(19) United States
(12) Patent Application Publication
(10) Pub. No.: US 2026/0081687 A1
(43) Pub. Date: Mar. 19, 2026

(54) VEHICLE OPTICAL COMMUNICATION

(71) Applicant: Ford Global Technologies, LLC, Dearborn, MI (US)

(72) Inventors: Michael Robertson, JR., West Bloomfield, MI (US); Venkatesh Krishnan, Canton, MI (US); Aaron Bradley Johnson, Allen Park, MI (US); Segundo Baldovino, Novi, MI (US)

(73) Assignee: Ford Global Technologies, LLC, Dearborn, MI (US)

(21) Appl. No.: 18/885,877

(22) Filed: Sep. 16, 2024

(51) Int. Cl. H04B 10/116; G01S 17/10

(52) U.S. Cl. CPC H04B 10/116; G01S 17/10

(57) ABSTRACT

A system including a computer having a processor and a memory. The memory includes instructions executable by the processor to illuminate a visible light source disposed in a trim element of a vehicle and transmit communication signals by modulating the visible light source.

### BACKGROUND

Wireless communication technologies such as Wi-Fi® and Bluetooth® use the radio frequency (RF) spectrum for communication. The RF spectrum is part of the electromagnetic spectrum that has frequencies ranging from approximately 3 Hz to 3,000 GHz. Typically, wireless connections can have speeds ranging from 1 to 54 Mbps.

Another wireless communication technology known as Li-Fi (Light Fidelity) makes use of Visible Light Communication (VLC) technology instead of the RF spectrum to transmit data. The visible light spectrum covers frequencies ranging from approximately 430,000 to 770,000 GHz, which is 10,000 times larger than the RF spectrum. This results in data transmission rates about 100 times faster than speeds achievable by Wi-Fi®.

### BRIEF DESCRIPTION OF THE DRAWINGS

FIG. 1 is a block diagram of an example system for a vehicle.

FIG. 2 is a diagram of an example front end of the vehicle in FIG. 1.

FIG. 3 is a cross-section view of an example light bar included in the grille of the vehicle front end taken about line 3-3 shown in FIG. 2.

FIG. 4 is a cross-section view of an example trim element included on the vehicle front end taken about line 4-4 shown in FIG. 2.

FIG. 5 is a diagram illustrating an example illumination pattern for the light sources of the trim element shown in FIGS. 2 and 4.

FIG. 6 is a block diagram illustrating example vehicle optical communication applications.

FIG. 7 is a process flow diagram illustrating an example process for vehicle optical communication.

### DETAILED DESCRIPTION

It can be useful for vehicles to wirelessly communicate with other entities, for example, other vehicles, persons, public service vehicles, and/or traffic signals, etc. This disclosure provides vehicle optical communications via an illuminated grille and/or other illuminated trim elements of the vehicle using available spectrum and high data transmission rates of Li-Fi. Visible light sources, such as light emitting diodes (LEDs), are disposed in the trim elements of the vehicle. The LEDs used to illuminate the trim elements also serve as the light sources to communicate with other vehicles and traffic control devices via Li-Fi, for example.

Disclosed herein is a system including a computer having a processor and a memory. The memory includes instructions executable by the processor to illuminate a visible light source disposed in a trim element of a vehicle and transmit communication signals by modulating the visible light source.

The trim element can be part of a grille of the vehicle.

The system can further include a photodiode receiver.

The instructions to transmit communication signals can include instructions to modulate the visible light source according to IEEE 802.11bb.

The visible light source can be disposed on a circuit board.

The system can further include an infrared LIDAR emitter.

The infrared LIDAR emitter can be disposed on the circuit board.

The instructions to modulate the visible light can include instructions to modulate the visible light source at a frequency that is imperceptible to humans.

The instructions to transmit communication signals can include instructions to communicate with another vehicle, a traffic signal, a public service vehicle, a phone, a watch, or a mobility aid.

The visible light source can be a first visible light source and the system can further include a second visible light source.

The instructions to illuminate the trim element with the visible light source can include instructions to illuminate the first visible light source and the second visible light source according to a user selected pattern.

The instructions to transmit communication signals can include instructions to communicate with a phone of the user.

The trim element can be an exterior trim element disposed on an exterior of the vehicle.

Disclosed herein is a method including illuminating a trim element of a vehicle with a visible light source and transmitting communication signals by modulating the visible light source.

Transmitting communication signals can include modulating the visible light source according to IEEE 802.11bb.

Transmitting communication signals can include modulating the visible light source at a frequency that is imperceptible to humans.

The communication signals can be configured to communicate with another vehicle, a traffic signal, a public service vehicle, a phone, a watch, or a mobility aid.

The method can include illuminating a second trim element of the vehicle with a second visible light source.

The method can include illuminating the trim element and the second trim element according to a user selected pattern.

Transmitting communication signals can include communicating with a phone of the user.

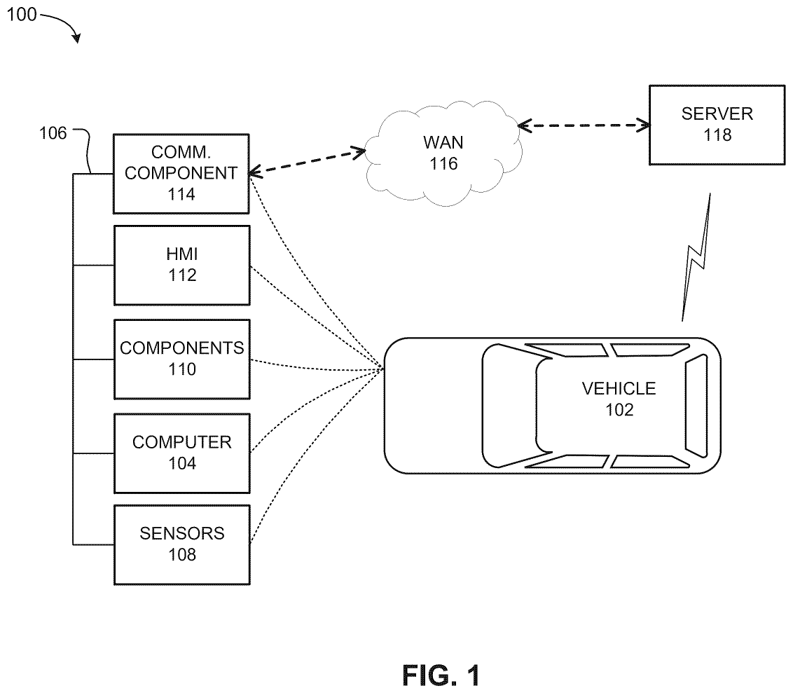

FIG. 1 is a block diagram of an example vehicle system 100. As shown in FIG. 1, system 100 includes a vehicle 102, which in turn includes computer 104 that is communicatively coupled, e.g., via vehicle network 106, to various elements including sensors 108, subsystems or components 110, such as steering, propulsion, braking, human machine interface (HMI) 112, and communication component 114. Computer 104, and server 118 discussed below, include a processor and a memory. A memory of computer 104, such as those described herein, includes one or more forms of non-transitory media readable by computer 104, and can store instructions executable by computer 104 for performing various operations, such that the vehicle computer is configured to perform the various operations, including those disclosed herein.

For example, computer 104 can include a generic computer with a processor and memory as described above and/or may comprise an electronic control unit (ECU) or a controller for a specific function or set of functions, and/or a dedicated electronic circuit including an ASIC (application specific integrated circuit) that is manufactured for a particular operation, (e.g., an ASIC for processing data from sensors and/or communicating data from sensors 108). In another example, computer 104 may include an FPGA (Field-Programmable Gate Array), which is an integrated circuit manufactured to be configurable by a user. In example embodiments, a hardware description language such as VHDL (Very High-Speed Integrated Circuit Hardware Description Language) may be used to describe digital and mixed-signal systems such as FPGA and ASIC. For example, an ASIC is manufactured based on VHDL programming provided pre-manufacturing, whereas logical components inside an FPGA may be configured based on VHDL programming, e.g., stored in a memory electrically connected or coupled to the FPGA circuit. In some examples, a combination of processor(s), ASIC(s), and/or FPGA circuits may be included in computer 104. Further, computer 104 may include a plurality of computers in the vehicle (e.g., a plurality of ECUs or the like) operating together to perform operations ascribed herein to the computer 104.

A memory of computer 104 can include any type, such as hard disk drives, solid state drives, or any other volatile or non-volatile media. The memory can store the collected data transmitted by sensors 108. The memory can be a separate device from computer 104, and computer 104 can retrieve information stored by the memory via a communication network in the vehicle such as vehicle network 106, e.g., over a controller area network (CAN) bus, a local interconnect network (LIN) bus, a wireless network, etc. Alternatively or additionally, the memory can be part of computer 104, for example, as a memory internal to computer 104.

Computer 104 can include or access instructions to operate one or more components 110 such as vehicle brakes, propulsion (e.g., one or more of an internal combustion engine, electric motor, hybrid engine, etc.), steering, climate control, interior and/or exterior lights, infotainment, navigation etc., as well as to determine whether and when computer 104, as opposed to a human operator, is to control such operations. Computer 104 can include or be communicatively coupled, e.g., via vehicle network 106, to more than one processor, which can be included in components 110 such as sensors 108, electronic control units (ECUs) or the like included in the vehicle for monitoring and/or controlling various vehicle components, e.g., a powertrain controller, a brake controller, a steering controller, etc.

Computer 104 may be generally arranged for communications on vehicle network 106 that can include a communications bus in the vehicle, such as a controller area network CAN or the like, and/or other wired and/or wireless mechanisms. Vehicle network 106 corresponds to a communications network, which can facilitate exchange of messages between various onboard vehicle devices, e.g., sensors 108, components 110, computer 104. Computer 104 can be generally programmed to send and/or receive, via vehicle network 106, messages to and/or from other devices of vehicle 102, e.g., any or all of ECUs, sensors 108, actuators, components 110, communications component 114, HMI 112. For example, various component 110 subsystems (e.g., components 110) can be controlled by respective ECUs.

Further, in implementations in which computer 104 actually comprises a plurality of devices, vehicle network 106 may be used for communications between devices represented as computer 104 in this disclosure. For example, vehicle network 106 can provide a communications capability via a wired bus, such as a CAN bus, a LIN bus, or can utilize any type of wireless communications capability. Vehicle network 106 can include a network in which messages are conveyed using any other wired communication technologies and/or wireless communication technologies, e.g., Ethernet, Wi-Fi®, Li-Fi, Bluetooth®, etc. Additional examples of protocols that may be used for communications over vehicle network 106 in some implementations include, without limitation, Media Oriented System Transport (MOST), Time-Triggered Protocol (TTP), and FlexRay. In some implementations, vehicle network 106 can represent a combination of multiple networks, possibly of different types, that support communications among devices onboard a vehicle. For example, vehicle network 106 can include a CAN bus, in which some in-vehicle sensors and/or components communicate via a CAN bus, and a wired or wireless local area network in which some device in vehicle communicate according to Ethernet, Wi-Fi®, Li-Fi, and/or Bluetooth® communication protocols.

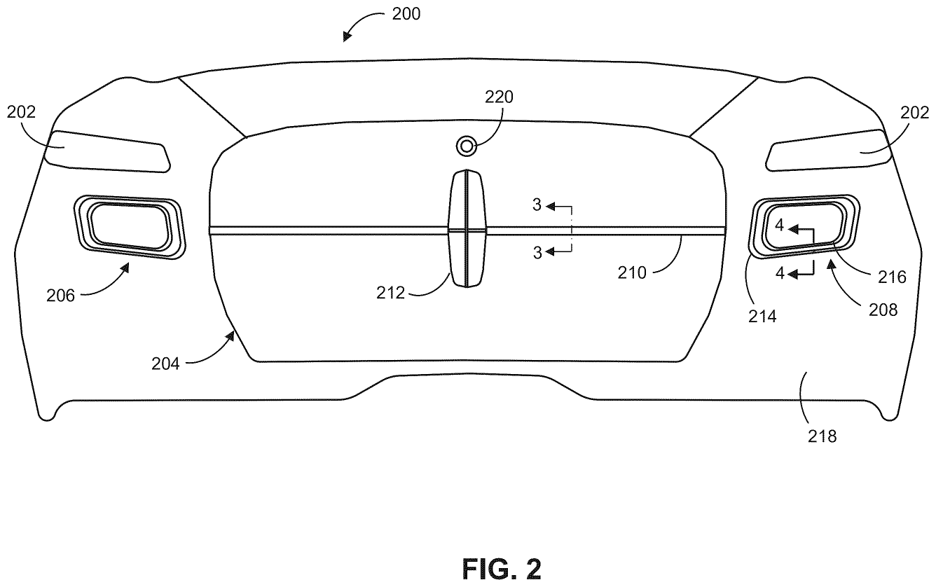

Vehicle 102 typically includes a variety of sensors 108. Sensors 108 can include a suite of devices that can obtain one or more measurements of one or more physical phenomena. Some of sensors 108 can detect data that characterize the operational environment of the vehicle, such as vehicle speed (e.g., from vehicle wheel speed sensors), vehicle towing parameters, vehicle braking parameters, engine torque output, engine and transmission temperatures, battery temperatures, vehicle steering angles, etc. Some of sensors 108 can detect data that characterize the physical environment of vehicle 102, such as ambient air temperature, humidity, weather conditions (e.g., rain, snow, etc.), parameters related to the inclination or gradient of a road or other type of path on which the vehicle is proceeding, etc. In examples, sensors 108 can operate to detect the position and/or orientation of the vehicle utilizing, for example, signals from a Global Navigation Satellite System (GNSS) sensor, e.g., GLONASS, GPS, Galileo, Beidou; accelerometers, such as piezo-electric or microelectromechanical systems MEMS; gyroscopes such as rate, ring laser, or fiber-optic gyroscopes; inertial measurement units IMU; and magnetometers. In examples, sensors 108 can include sensors to detect aspects of the environment external to vehicle 102, such as radar sensors, scanning laser range finders, cameras, etc. Sensors 108 can also include a photodiode light sensor 220 (FIG. 2) for Li-Fi communication. Sensors 108 can also include light detection and ranging (LIDAR) sensors, which operate to detect distances to objects by emitting a laser pulse and measuring the time of flight for the pulse to travel to the object and back. Sensors 108 may include a controller and/or a microprocessor, which executes instructions to perform, for example, analog-to-digital conversion to convert sensed analog measurements and/or observations to input signals that can be provided to computer 104, e.g., via vehicle network 106.

Computer 104 can be configured for utilizing vehicle-to-vehicle (V2V) communications via communication component 114 and/or may interface with devices outside of the vehicle, e.g., through wide area network (WAN) 116 via V2V communications. Computer 104 can communicate outside of vehicle 102, such as via vehicle-to-infrastructure (V2I) communications, vehicle-to-everything (V2X) communications, or V2X including cellular communications C-V2X, and/or wireless communications cellular dedicated short-range communications DSRC, etc. Communications outside of vehicle 102 can be facilitated by direct radio frequency communications, visible light optical communications (e.g., Li-Fi), and/or via network server 118. Communications component 114 can include one or more mechanisms by which computer 104 communicates with vehicles outside of vehicle 102, including any desired combination of wireless, e.g., cellular, wireless, satellite, microwave, radio frequency, visible light communication mechanisms and any desired network topology or topologies when a plurality of communication mechanisms are used.

Vehicle 102 can include HMI 112, e.g., one or more of an infotainment display, a touchscreen display, a microphone, a speaker, a haptic device, etc. A user, such as the operator of vehicle 102, can provide input to devices such as computer 104 via HMI 112. HMI 112 can communicate with computer 104 via vehicle network 106, e.g., HMI 112 can send a message including the user input provided via a touchscreen, microphone, a camera that captures a gesture, etc., to computer 104, and/or can display output, e.g., via a display, speaker, etc. Further, operations of HMI 112 can be performed by a portable user device (not shown) such as a smart phone or the like in communication with computer 104, e.g., via Bluetooth® or the like.

WAN 116 can include one or more mechanisms by which computer 104 may communicate with server 118. Server 118 can include an apparatus having one or more computing devices, e.g., having respective processors and memories and/or associated data stores, which may be accessible via WAN 116. In example embodiments, vehicle 102 could include a wireless transceiver (i.e., transmitter and/or receiver) to send and receive messages outside of vehicle 102. Accordingly, the network can include one or more of various wired or wireless communication mechanisms, including any desired combination of wired e.g., cable and fiber and/or wireless, e.g., cellular, wireless, satellite, microwave, and radio frequency communication mechanisms and any desired network topology or topologies when multiple communication mechanisms are utilized. Exemplary communication networks include wireless communication networks, e.g., using Bluetooth®, Bluetooth® Low Energy BLE, IEEE 802.11, V2V or V2X such as cellular V2X CV2X, DSRC, etc., local area networks and/or wide area networks 116, including the Internet.

FIG. 2 illustrates an example front end 200 of the vehicle 102. The front end 200 can include headlights 202 and a grille 204. The front end 200 can also include trim elements. The trim elements can include exterior and interior trim elements. Excluding headlights, tail-lights, and turn indicators, exterior trim elements can include, for example, a horizontal light bar 210, a badge 212, and bezels 206, 208, each of which can include a visible light source such as visible light LEDs. Exterior trim elements can also include vehicle badging, mouldings, surrounds, bezels, grille elements, sideview mirrors, and the like. The visible light LEDs of the trim elements serve the dual functions of illuminating the trim elements and providing the visible light sources for Li-Fi communication. A photodiode receiver 220 can also be positioned on or in the front end 200 of the vehicle 102. The photodiode receiver 220 can be used to receive communications from other Li-Fi equipped vehicles and/or road signs.

In some examples, the bezels 206 and 208 can each include nested light rings 214 and 216. The bezels 206 and 208 can be trim elements that surround auxiliary lights (e.g., daytime running lights (DRL) or fog lights), air-intake vents, or turn indicators, for example. In the depicted example, the illuminated light rings 214 and 216 of the bezels 206 and 208 can be rounded trapezoids, for example. Although the trim elements are shown and described as being positioned on the front end of the vehicle, trim elements can be located on a rear, a top, and/or sides of the vehicle. Furthermore, the shape, orientation, dimensions, and positions of the depicted trim elements are for example only and should not be construed as limiting. Additional photodiode receivers 220 can also be positioned on a rear, a top, and/or sides of the vehicle.

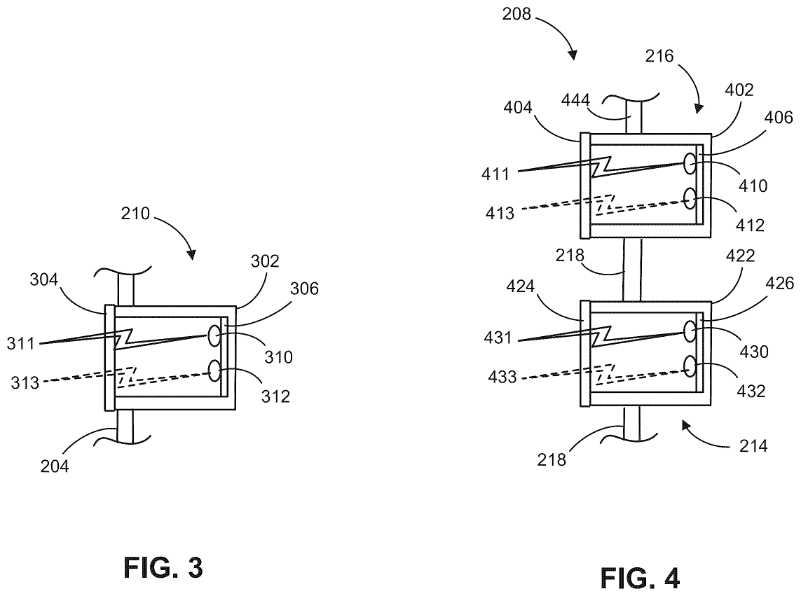

The light bar 210 and the badge 212 can be part of the grille 204. For example, the badge 212 and light bar 210 can be mounted or fastened directly to the grille 204. In another example, at least a portion of the badge and/or light bar can be integrally formed (e.g., molded, or bonded) with the grille. In an example, the channel 302 (FIG. 3) of light bar 210 can be integrally molded with the grille structure 204.

FIG. 3 illustrates a cross-section of the light bar 210. The light bar 210 is part of, or integrated with, the grille 204. For example, the light bar can 210 be fastened to or integrally molded to the grille 204. The horizontal bar 210 can be illuminated by multiple visible light LEDs 310 positioned along a length of the bar 210. The LEDs 310 emit visible light to illuminate the trim element and transmit data via Li-Fi.

The light bar 210 can include an elongated channel 302 enclosed by a lens 304. The channel 302 can enclose a substrate (e.g., circuit board) 306 that carries the visible light LEDs 310. In some examples, the trim elements can also include infrared emitting LIDAR LEDs 312. Thus, the visible light sources and the infrared LIDAR emitters can be disposed on the same circuit board. The visible light 311 emitted by the visible light LEDs 310 and the infrared light 313 emitted by the LIDAR LEDs 312 are transmitted through the lens 304.

Illuminating the trim elements with the same LEDs that are used for Li-Fi communication provides an efficient compact package. Including the LIDAR LEDs on the same substrate with the visible LEDs further enhances the functional capabilities of the trim elements.

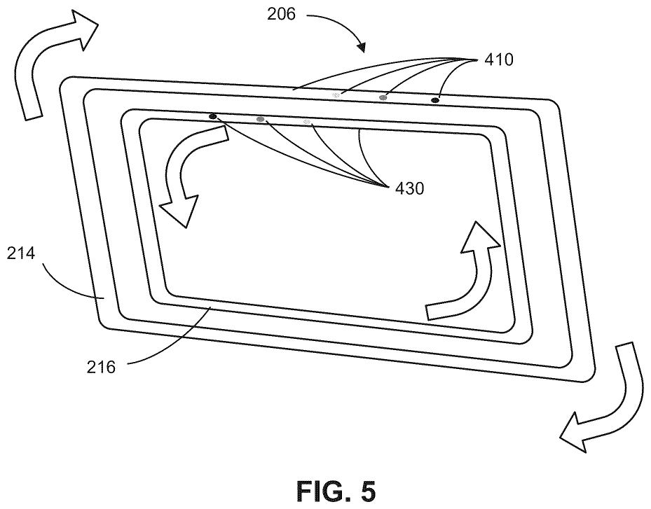

FIG. 4 illustrates a cross-section of the bezel 208 including the nested light rings 214 and 216. The bezels can be mounted in or around the grille area of the front end, or bumper, of vehicle 102. The bezels can be mounted in or on a front-end panel 218 and surround an auxiliary lighting lens or turn indicator lens 444, for example.

The light rings 214, 216 can have a construction similar to that of the light bar 210. However, the bezel light rings 214 and 216 are nested rings rather than an elongate bar. The rings 214 and 216 can be illuminated by multiple LEDs 410 and 430 positioned around the rings 214 and 216, respectively. The LEDs 410 and 430 emit visible light to illuminate the trim element and transmit data via Li-Fi. The light rings 214 and 216 can include respective ring-shaped channels 402 and 422 enclosed by corresponding lenses 404 and 424. The channels 402 and 422 can enclose substrates (e.g., circuit boards) 406 and 426 that carry the visible light LEDs 410 and 430 and the infrared emitting LIDAR LEDs 412 and 432. The visible light 411, 431 emitted by the visible light LEDs 410, 430 and the infrared light 413, 433 emitted by the LIDAR LEDs 412, 432 are transmitted through the lenses 404 and 424.

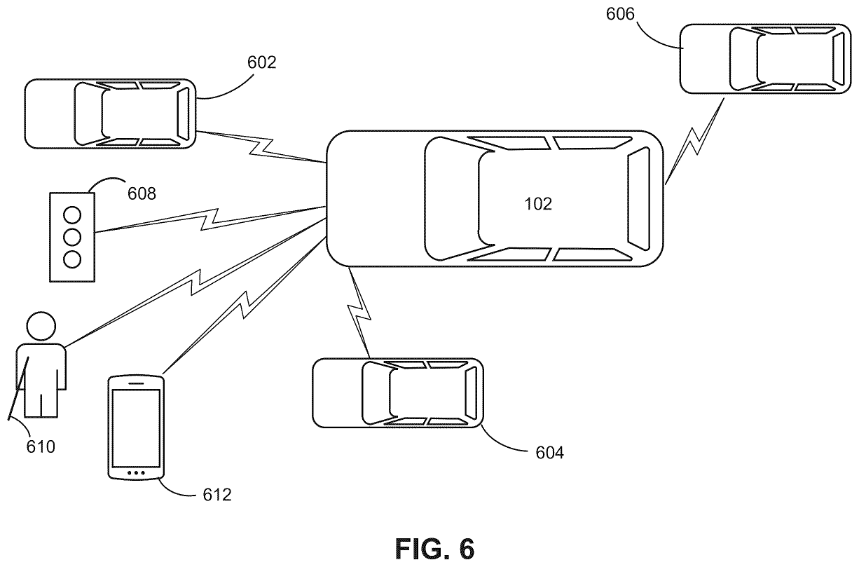

With reference to FIG. 5, the LEDs in the trim elements can be illuminated in different sequences creating various patterns and visual effects. For example, the outer nested light ring 214 (e.g., a first visible light source) and the inner light ring 216 (e.g., a second visible light source) can be illuminated according to a user selected pattern. The pattern can be selected by the user via the HMI 112 or the user's mobile device 612 (FIG. 6), for example. In an example pattern, the LEDs 430 of the outer light ring 214 can be sequentially illuminated in a clockwise direction and at the same time the LEDs 410 of the inner light ring 216 can be illuminated in a counter-clockwise direction.

These patterns can be used in conjunction with the vehicle turn indicators and/or as part of a vehicle welcome sequence. In some examples, the bezels 206 and 208 surround turn indicators. In response to a right-hand turn indication, the LEDs 430 of the outer light ring 214 can be sequentially illuminated in a clockwise direction and at the same time the LEDs 410 of the inner light ring 216 can be illuminated in a counter-clockwise direction or vice-versa.

A welcome sequence can be initiated upon detection of a user key fob or mobile device as a user approaches the vehicle. The welcome sequence can include illuminating the badge 212, followed by the horizontal bar lights 210, and then the inner and outer ring lights of the bezels 206 and 208 can be illuminated in counter-rotating patterns as described above.

In Li-Fi communications the transmission of data is accomplished by modulating the light emitted by the visible light source (the transmitter) and is received by a photodiode (the receiver). The visible light emitted by the light source, i.e., LEDs, is modulated at a frequency that is imperceptible to humans, which is above approximately 50 to 90 Hz. Li-Fi can use the visible light spectrum which provides 1000 times more spectrum than radio frequency. In some examples, each trim element, or group of elements, can be controlled independently such that each trim element can communicate with a different vehicle, a person, etc.

As illustrated in FIG. 6, the vehicle 102 can use Li-Fi to communicate with other vehicles 602, 604, and 606 in the vicinity. The vehicle sends Li-Fi messages to neighboring vehicles 602, 604, and 606 using the same visible light sources it uses for vehicle illumination. For example, when the vehicle 102 shifts into reverse, the Li-Fi system can alert neighboring vehicles, e.g., vehicle 606, that vehicle 102 is about to backup. If no acknowledgment is received from e.g., vehicle 606, an audible alert can be activated to caution the driver of vehicle 102 to be aware of surroundings when backing up. As another example, upon braking, the Li-Fi system of vehicle 102 can send signals or messages to forward and rearward vehicles 602 and 606, respectively, indicating that vehicle 102 is braking.

In response to a left-hand turn indication, the Li-Fi system can activate the LEDs in bezel 208 to visually indicate that vehicle 102 is moving left. The system can also modulate the LEDs in bezel 208 to communicate via Li-Fi with vehicle 604 to indicate that vehicle 102 is moving left.

Public service vehicles such as police cars, ambulances, etc., can be equipped with Li-Fi and can use predetermined signals or messages to change Li-Fi enabled traffic control devices 608 to allow public service vehicles to proceed through intersections. In some examples, as an public service vehicle approaches vehicle 102, it can communicate via Li-Fi to provide an audible alert indicating to the driver that the public service vehicle is approaching.

In some examples, the Li-Fi system can send messages to a user's smart watch or other mobile device 612. These messages can be regarding vehicle status, such as whether the vehicle's doors are locked or not. The vehicle 102 can also receive instructions from the user device via the photodiode receiver 220. These instructions can include instructions to lock or unlock the vehicle doors or select patterns for illuminating the vehicle's trim elements, e.g., horizontal light bar 210, badge 212, and bezels 206, 208.

The Li-Fi system can communicate with persons via a user devices such as a phone or smart watch, for example. In some examples, the Li-Fi system can communicate with a photodiode receiver of a visually impaired person's mobility aid 610 (e.g., a cane) by sending signals that cause the cane to vibrate indicating the presence of an oncoming vehicle.

In some examples, the vehicle 102 can communicate through Li-Fi with nearby vehicles or devices that have GPS, internet, cell service, satellite, best linear invariant estimator (BLIE) and/or Bluetooth® capabilities, for example. Thus, hands-free phone calls in vehicle 102 can be transmitted over Li-Fi; GPS communications can be transmitted over Li-Fi; and in the event a vehicle is disabled, a user has the option to send out Li-Fi broadcasts for roadside assistance, police, ambulance, and/or contact family members providing location information. Li-Fi can also be used to connect to the internet for software updates to the vehicle. For example, the vehicle 102 can communicate through Li-Fi with dealerships and maintenance and service facilities that have satellite, cell, and or cable communication capabilities.

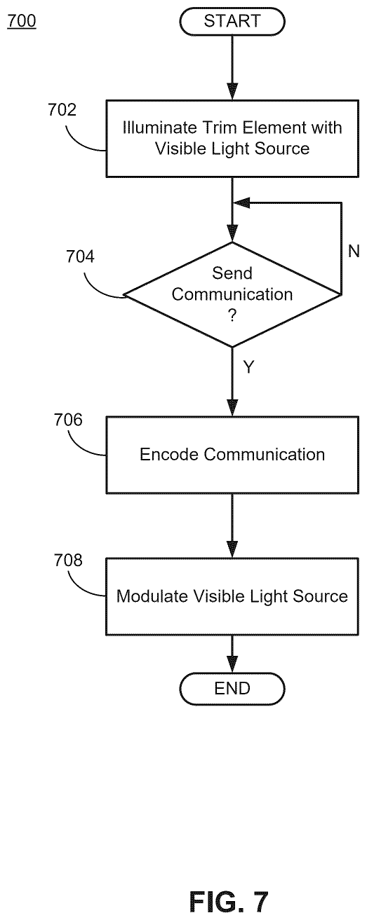

FIG. 7 is a process flow diagram illustrating an example process 700 for illuminating a trim element with a visible light source and using the visible light source for optical communications. Process 700 can be executed according to programming in a computer 104 included in the vehicle 102, for example. Process 700 includes multiple blocks that can be executed in the illustrated order. Process 700 could alternatively or additionally include fewer blocks or include the blocks executed in different orders.

Process 700 can begin at block 702, such as in response to vehicle 102 being placed into an ON state, or in a “drive” state to operate on a roadway, for example. In some examples, the process 700 can begin in response to sensing a key fob or mobile device.

At block 702, the computer 104 activates the visible light source to illuminate the trim element, such as horizontal light bar 210, badge 212, and/or bezels 206, 208.

At decision block 704, the computer 104 determines whether a communication is to be sent via the Li-Fi system. If a communication is to be transmitted, the process proceeds to block 706. Otherwise, the process remains in block 704 to monitor the system for outgoing communications. In an example, activation of a vehicle turn indicator can initiate a communication to other vehicles that the vehicle is changing direction.

At block 706 the computer 104 can encode the communication with a suitable protocol. At block 708 the computer 104 can transmit the communication signals by modulating the visible light source according to a suitable VLC protocol such as the IEEE 802.11bb standard. After block 708, process 700 ends.

Operations, systems, and methods described herein should always be implemented and/or performed in accordance with an applicable owner's/user's manual and/or safety guidelines.

The disclosure has been described in an illustrative manner, and it is to be understood that the terminology which has been used is intended to be in the nature of words of description rather than of limitation. Many modifications and variations of the present disclosure are possible in light of the above teachings, and the disclosure may be practiced otherwise than as specifically described.

In the drawings, the same reference numbers indicate the same elements. Further, some or all of these elements could be changed. With regard to the media, processes, systems, methods, etc. described herein, it should be understood that, although the steps of such processes, etc. have been described as occurring according to a certain ordered sequence, unless indicated otherwise or clear from context, such processes could be practiced with the described steps performed in an order other than the order described herein. Likewise, it further should be understood that certain steps could be performed simultaneously, that other steps could be added, or that certain steps described herein could be omitted. In other words, the descriptions of processes herein are provided for the purpose of illustrating certain embodiments and should in no way be construed so as to limit the claimed invention.

The adjectives first and second are used throughout this document as identifiers and, unless explicitly stated otherwise, are not intended to signify importance, order, or quantity.

The term exemplary is used herein in the sense of signifying an example, e.g., a reference to an exemplary widget should be read as simply referring to an example of a widget.

Use of in response to, based on, and upon determining herein indicates a causal relationship, not merely a temporal relationship.

Computer executable instructions may be compiled or interpreted from computer programs created using a variety of programming languages and/or technologies, including, without limitation, and either alone or in combination, Java, C, C++, Visual Basic, Java Script, Perl, Python, HTML, etc. In general, a processor e.g., a microprocessor receives instructions, e.g., from a memory, a computer readable medium, etc., and executes these instructions, thereby performing one or more processes, including one or more of the processes described herein. Such instructions and other data may be stored and transmitted using a variety of computer readable media. A file in a networked device is generally a collection of data stored on a computer readable medium, such as a storage medium, a random-access memory, etc. A computer readable medium includes any medium that participates in providing data e.g., instructions, which may be read by a computer. Such a medium may take many forms, including, but not limited to, non-volatile media and volatile media. Instructions may be transmitted by one or more transmission media, including fiber optics, wires, wireless communication, including the internals that comprise a system bus coupled to a processor of a computer. Common forms of computer-readable media include, for example, RAM, a PROM, an EPROM, a FLASH-EEPROM, any other memory chip or cartridge, or any other medium from which a computer can read.

What is claimed is:

1. A vehicle optical communication system, comprising:
a computer including a processor and memory, the memory including instructions executable by the computer to:
illuminate a visible light source disposed in a trim element of a vehicle; and
transmit communication signals by modulating the visible light source.

2. The system of claim 1, wherein the trim element is part of a grille of the vehicle.

3. The system of claim 1, further comprising a photodiode receiver.

4. The system of claim 1, wherein the instructions to transmit communication signals include instructions to modulate the visible light source according to IEEE 802.11bb.

5. The system of claim 1, wherein the visible light source is disposed on a circuit board.

6. The system of claim 5, further comprising an infrared LIDAR emitter.

7. The system of claim 6, wherein the infrared LIDAR emitter is disposed on the circuit board.

8. The system of claim 1, wherein the instructions to modulate the visible light include instructions to modulate the visible light source at a frequency that is imperceptible to humans.

9. The system of claim 1, wherein the instructions to transmit communication signals include instructions to communicate with another vehicle, a traffic signal, a public service vehicle, a phone, a watch, or a mobility aid.

10. The system of claim 1, wherein the visible light source is a first visible light source and further comprising a second visible light source.

11. The system of claim 10, wherein the instructions to illuminate the trim element with the visible light source include instructions to illuminate the first visible light source and the second visible light source according to a user selected pattern.

12. The system of claim 11, wherein the instructions to transmit communication signals include instructions to communicate with a phone of the user.

13. The system of claim 1, wherein the trim element is an exterior trim element disposed on an exterior of the vehicle.

14. A method, comprising:
illuminating a trim element of a vehicle with a visible light source; and
transmitting communication signals by modulating the visible light source.

15. The method of claim 14, wherein transmitting communication signals includes modulating the visible light source according to IEEE 802.11bb.

16. The method of claim 14, wherein transmitting communication signals includes modulating the visible light source at a frequency that is imperceptible to humans.

17. The method of claim 14, wherein the communication signals are configured to communicate with another vehicle, a traffic signal, an public service vehicle, a phone, a watch, or a mobility aid.

18. The method of claim 14, further comprising illuminating a second trim element of the vehicle with a second visible light source.

19. The method of claim 18, further comprising illuminating the trim element and the second trim element according to a user selected pattern.

20. The method of claim 19, wherein transmitting communication signals includes communicating with a phone of the user.
